(19) United States
(12) Patent Application Publication
(10) Pub. No.: US 2005/0245280 A1
(43) Pub. Date: Nov. 3, 2005

(54) Apparatus, and associated method, for facilitating closed-loop power control in a communication system utilizing a multiple transmit antenna configuration

(76) Inventors: Ke Liu, Madison, WI (US); Balaji Raghothaman, Allen, TX (US); Jianzhong Zhang, Irving, TX (US)

Correspondence Address: SCHEEF & STONE, L.L.P., 5956 SHERRY LANE, SUITE 1400, DALLAS, TX, 75225, US

(21) Appl. No.: 10/836,808

(22) Filed: Apr. 30, 2004

(51) Int. Cl. H04B 7/00

(52) U.S. Cl. 455/522

(57) ABSTRACT

Apparatus, and an associated method, for compensating for the effects of fading, or other distortion, in an MIMO communication system. Analysis is made at a receiving station, such as through channel estimation by a channel estimator, of communication conditions on different sub-channels, defined by different communication paths upon which data streams are communicated to the receiving station from different transmit antenna transducers. Power controllers generate power change requests responsive to the channel estimations. The power change requests are returned to a sending station by way of a feedback channel. And, the power levels at which data is transmitted from different transmit antennas is correspondingly changed.

The present invention relates generally to a manner by which to facilitate closed-loop power control in a radio communication system that utilizes a multiple-transmit antenna implementation, such as a MIMO (Multiple-Input, Multiple-Output) radio communication system. More particularly, the present invention relates to apparatus, and an associated method, by which to form power control commands for use, pursuant to closed-loop power control, selectably to control power levels at which data is transmitted from individual antennas of a receiving station having multiple transmit antennas.

By altering the power levels of data transmitted from individual ones of the transmit antennas, power levels that best provide for the communication of data transmitted by different ones of the transmit antennas are selectable. Compensation is made for fading, or other non-ideal, communication conditions through alteration of power levels at which data is transmitted. Only minimal amounts of feedback are needed to effectuate the power control, requiring only a minimal feedback bandwidth. The need otherwise to alter coding levels through use of a variable rate coder, and associated complexities, to compensate for non-ideal communication conditions, is obviated.

### BACKGROUND OF THE INVENTION

Operation of a communication system provides for the communication of data between the communication stations of a set of communication stations. At least one of the communication stations of the set forms a sending station, and at least another communication station of the set forms a receiving station. A communication service is effectuated by communicating data from the sending station to the receiving station. The sending station, if necessary, converts the data that is to be communicated pursuant to the effectuation of the communication service into a form to permit its communication upon a communication channel that extends between the sending and the receiving stations. And, the receiving station operates to convert the data communicated thereto into a form to facilitate recovery of the informational content thereof.

Different types of communication systems have been developed and are used to effectuate different types of communication services. As advancements in communication technologies permit, additional types of communication systems shall likely continue to be developed and used.

A radio communication system is a type of communication system that utilizes radio channels upon which to communicate data between sending and receiving stations. The radio channels are defined upon radio links, defined of portions of the electromagnetic spectrum, extending between the sending and receiving stations. In contrast to conventional wireline communication systems that require fixed, i.e., wireline, connections to extend between the sending and receiving stations to form a communication path therebetween upon which to define communication channels, no corresponding wireline connection is required in a radio communication system. Because the use of radio channels obviates the need for fixed, wireline connections to interconnect the sending and receiving stations, communication of data by way of a radio communication system is possible at, and between, locations at which communications by way of a wireline communication system would not be possible if the communication stations cannot be interconnected by way of wireline connections. Additionally, a radio communication system is implementable as a mobile communication system in which one or more of the communication stations is permitted mobility. Mobility of communications in a wireline communication system, in contrast, is limited due to the need to interconnect the communication stations by way of fixed connections.

A cellular communication system is a type of radio communication system. Significant portions of the populated areas of the world are encompassed by the networks of cellular communication systems. Communication of data is effectuated in a cellular communication system between radio transceivers forming portions of a cellular communication network and portable radio transceivers, herein referred to as mobile stations, communications are effectuable generally between a mobile station and the network of the cellular communication system when the mobile station is positioned at any location within the coverage area of the network of the system. While cellular communication systems that were first-implemented provided only voice and limited data communication capabilities, advanced-generation, cellular communication systems are capable of providing data-intensive communication services. And, proposals for successor-generation systems provide additional data capabilities to provide even more data-intensive capabilities.

Communication difficulties sometimes occur in cellular radio, as well as other types of, communication systems. For instance, fading conditions on the radio channel upon which data is communicated distorts the value of the data. If fading conditions are significant, and compensation cannot be made at a receiving station for the fading of the data, the informational content of the data cannot be successfully be recovered at the receiving station.

Various diversity schemes are sometimes utilized to compensate for fading. Generally, diversity schemes increase the redundancy of data that is sent by a sending station to a receiving station. Increasing the time redundancy of the data, for instance, increases the likelihood that the informational content of the data can be recovered, when received at a receiving station. Space diversity, sometimes alternately, or additionally, is utilized. When space diversity is created, data that is communicated by a sending station to a receiving station is communicated by way of different communication paths. Fading conditions along the separate communication paths might differ, and fading of data communicated upon one communication path to prevent its successful delivery might be compensated for by successful delivery of the data communicated along another communication path. Space diversity is provided, for instance, through the use of multiple antennas. Multiple transmit antennas are positionable at a sending station. And, multiple antennas are also positionable at a receiving station.

A communication system in which both a sending station includes multiple transmit antennas and a receiving station includes multiple receive antennas is sometimes referred to as an MIMO (Multiple-Input, Multiple-Output) communication system. In an MIMO communication system, independent data streams are transmitted at different ones of the multiple transmit antennas. The potential throughput of data in an MIMO communication system increases, in proportion to the number of transmit antennas from which independent data streams are communicated.

Compensation can also be made for fading conditions by increasing the power level at which data is communicated by a sending station. By increasing the power of the transmitted data, data values, of increased power levels, are more likely to be detectable at a receiving station, even when communicated upon a fading channel.

When the different ones of the transmit antennas of an MIMO communication system transmit independent data streams, spatial diversity is not used to compensate for the effects of fading, but the concurrent transmission on the concurrent data streams increases the throughput rate of the communicated data. Time diversity or power level change must instead be utilized to compensate for the communication of the data upon the fading channels. And, because each different communication path exhibits different levels of fading, the amount of time diversity introduced into the data should be made on a path-by-path basis. Similarly, power level changes should also be made on a path-by-path basis.

An existing proposal by which to compensate for fading in an MIMO communication system utilizes a feedback scheme in which coding rates are changed depending upon levels of fading. Time diversity is created through the use of channel coders. However, use of variable rate coders is generally complex and expensive, and the use of fixed rate encoders is generally preferred.

Accordingly, a manner by which to compensate for the effects of fading, utilizing a closed-loop feedback scheme, in an MIMO communication system is needed.

It is in light of this background information related to communications in a communication system that utilizes multiple transmit antennas that the significant improvements of the present invention have evolved.

### SUMMARY OF THE INVENTION

The present invention, accordingly, advantageously provides apparatus, and an associated method, for facilitating closed-loop power control in a radio communication system that utilizes a multiple transmit antenna implementation, such as an MIMO (Multiple-Input, Multiple-Output) radio communication system.

Through operation of an embodiment of the present invention, a manner is provided by which to perform power control commands for use, pursuant to closed-loop power control, selectably to control power levels at which data is transmitted from individual antennas of a sending station having multiple transmit antennas.

Closed-loop power control is provided to control the power levels at which data is transmitted from individual ones of the transmit antennas of the sending station. Analysis is made at the receiving station of data received thereat. The analysis detects, through channel estimation, sub-channels defined by the communication paths extending to the receiving station from individual ones of the transmit antennas of the sending station. And, responsive to the estimation of the sub-channels, determinations are made as to whether the power levels of the data communicated on the individual ones of the sub-channels should be increased or decreased. Power level change determinations are made on a sub-channel-by-sub-channel basis, thereby to control, based upon actually-received data at the receiving station, thereby best to determine at what power levels that the data should be transmitted from the individual ones of the transmit antennas.

Responsive to the analysis, feedback indications are generated to indicate whether the power levels at which the data is communicated from the individual ones of the transmit antennas should be changed by increasing or decreasing the power levels of the data transmitted therefrom. And, the feedback indications are returned by the receiving station to the sending station by way of a feedback channel. Because only minimal amounts of feedback information are required to be returned to the sending station, the bandwidth of the feedback channel is correspondingly minimal.

In one aspect of the present invention, data sent by a sending station as independent data streams by separate transmit antennas of the sending station are communicated at a fixed coding rate. Power control is effectuated to compensate for fading, or other distortion, detected upon the independent data streams sent by the individual ones of the transmit antennas. The coding rate remains unchanged, permitting a conventional, fixed rate coder to be used to encode the data. A lowered-complexity scheme is thereby provided by which to compensate for fading in an MIMO system as variable rate coding and, more particularly, different coding rates of data applied to different ones of the transmit antennas is not required to compensate for the fading conditions on individual ones of the communication paths.

In another aspect of the present invention, power control is provided in a layered manner and utilizes layered space-time processing techniques. The layered space-time processing is utilized to create a series of parallel sub-channels, corresponding in number to the transmit antennas from which data streams are transmitted by a sending station. The complexity, and related performance, of the processing is selectable, at least as processing criteria pursuant to which the layered space-time processing is performed. Through analysis of the constructed sub-channels, determinations are made as to whether the signal-to-noise ratio (SNR) of the data of the data stream communicated upon the sub-channel is adequate. If not, a power change request is generated at the receiving station. The power change request is returned to the sending station to request that the power level of the data stream be altered, e.g., incrementally increased or incrementally decreased.

In another aspect of the present invention, the sending station receives the power change requests to alter the power levels at which individual ones of the data streams are transmitted by corresponding transmit antennas of the sending station. And, responsive to the received request, the sending station effectuates the power change requests. By generating incremental power change requests, the amount of bandwidth required of a feedback channel to communicate the power change requests back to the sending station is minimal. And, because the compensation for the fading is effectuated through power changes of the transmit power levels, the power control is transparent to the coding apparatus of the sending station.

In one implementation, the feedback power control scheme is implemented in a cellular communication system in which the sending station forms a base transceiver station of a cellular network. And, the receiving station forms a mobile station operable in the cellular communication system. In a further implementation, two-way, closed-loop power control is effectuated also with the send part of the mobile station and the receive part of the base transceiver station. Data that is to be communicated by a base transceiver station to a mobile station to effectuate a communication service therebetween is coded by a fixed-rate codec and space-time encoded. Independent data streams are applied to a plurality of transmit antennas of the base transceiver station. Independent data streams are transmitted from the respective transmit antennas and are communicated to the mobile station. The mobile station includes one or more receive antennas that detects the transmitted data streams. Operations at the mobile station estimate the sub-channels upon which individual ones of the data streams are communicated to the mobile station. Determinations are made of the communication conditions, e.g., by way of determination of the signal-to-noise ratios of the detected data streams, and power control change requests are generated as a result. The power control change requests are returned by way of a feedback channel to the base transceiver station, and the base transceiver station effectuates power changes responsive to the values of the power change requests. As communication conditions change, the power levels at which the data is transmitted by the individual ones of the transmit antennas correspondingly change quickly, efficiently, and in closed-loop manner.

In these and other aspects, therefore, apparatus, and an associated method, is provided for a radio communication system. The radio communication system has a sending station having a first selected number of transmit antennas from which selectably to send data upon a communication channel susceptible to distortion. And, the radio communication system has a receiving station having a second selected number of receive antennas at which to detect the data communicated by the sending station upon the communication channel. Effectuation of closed-loop power control by which to control power levels at which the data is communicated by individual ones of the transmit antennas is facilitated. A detector is positioned at the receiving station and is coupled to the second selected number of receive antennas to receive indications of the data detected at individual ones of the receive antennas. The detector defines a first sub-channel and at least a second sub-channel. Each of the first and at least second sub-channels are defined in parallel with one another. Substantially independent data streams of the data are communicated upon individual ones of the first and at least second sub-channels. A first power controller is adapted to receive indications of power levels of a first data stream communicated upon the first sub-channel defined by the detector. The first power controller generates first power control commands for return to the sending station to control power levels of the first data stream subsequently communicated by the sending station. At least a second power controller is adapted to receive indications of power levels of at least a second data stream communicated upon the at least the second sub-channel defined by the detector. The at least the second power controller generates at least second power control commands for return to the sending station to control power levels of the at least the second data stream subsequently communicated by the sending station.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

FIG. 1 illustrates a functional block diagram of a communication system in which an embodiment of the present invention is operable.

FIG. 2 illustrates a partial signal, partial process, diagram representative of operation of the communication system shown in FIG. 1 pursuant to an embodiment of the present invention.

FIG. 3 illustrates a method flow diagram listing the method steps of the method of operation of an embodiment of the present invention.

### DETAILED DESCRIPTION

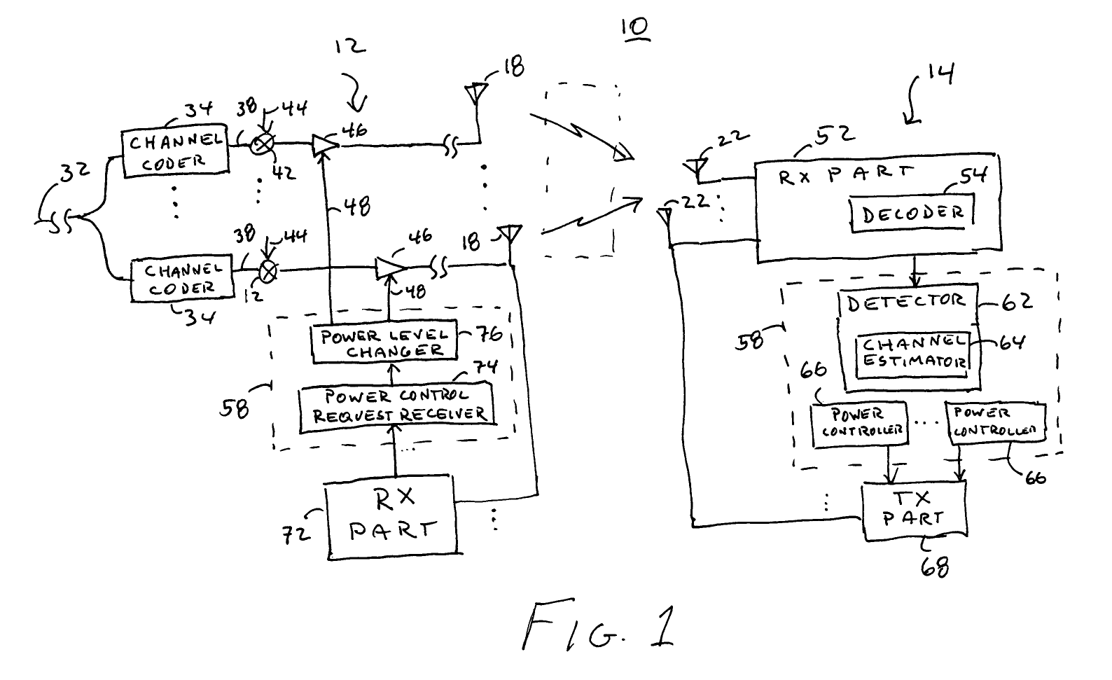

Referring to FIG. 1, a communication system, shown generally at 10, provides for the communication of data between a set of communication stations, here communication stations 12 and 14. The communication stations 12 and 14 are representative, for instance, of a base transceiver station and a mobile station operable in a cellular communication system. While the following description shall describe exemplary operation of the communication system 10 in which the communication station 12 forms a base transceiver station and the communication station 14 forms a mobile station, an embodiment of the present invention is analogously implementable in any of various other radio, and other, communication systems. That is to say, more generally, the communication system 10 forms a MIMO (Multiple-Input, Multiple-Output) communication system that provides for data communications between a set of communication stations, here represented by the communication stations 12 and 14.

Additionally, while the following description shall describe exemplary operation of data sourced at the base transceiver station forming the communication station 12 for delivery to the mobile station forming the communication station 14, operation of an embodiment of the present invention can analogously be described with respect to data sourced at the mobile station for delivery to the base transceiver station. That is to say, the communication station 12 is alternately representative of a mobile station at which data is sourced and the communication station 14 is alternately representative of a base transceiver station to which the data sourced at the mobile station is delivered. And, in a further implementation, while not separately shown, an embodiment of the present invention is also implementable in a communication system in which the communication stations of the base transceiver and mobile stations each include send and receive parts for sending and receiving data pursuant to effectuation of data communication services. Elements forming the communication stations 12 and 14, in such an implementation, are embodied at both of the communication stations to effectuate the two-way communication services pursuant to an embodiment of the present invention.

The base transceiver station formed of the communication station 12 includes a plurality of transmit antennas 18. M transmit antennas operate to transduce data applied thereto into electromagnetic form for communication upon a communication channel 20 to the mobile station formed of the communication station 14. The data communicated by the different ones of the transmit antennas form the multiple inputs of the MIMO communication system.

The mobile station formed of the communication station 14 includes a plurality of receive antennas 22. N receive antennas are positioned to detect the data communicated by the base transceiver station by way of the communication channel. Data detected at the receive antennas form the multiple outputs of the communication system.

The data communicated by the different ones of the transmit antennas upon the communication channel are communicated by way of different communication paths, of which the arrows 24 and 26 are representative. And, the data detected by the receive antennas include component portions of the data sent by the individual ones of the transmit antennas. The communication channel is not an ideal channel and is susceptible to distortion, such as distortion caused by fading conditions. Because the data is communicated by way of the different communication paths, the amount of fading exhibited by the data communicated upon different ones of the communication paths differ with the level of fading exhibited by data communicated by way of others of the communication paths. And, as noted previously, if the fading conditions are significant, the informational content of the data communicated on the communication path that exhibits such levels of fading cannot successfully be recovered.

Operation of an embodiment of the present invention provides a manner by which to facilitate, pursuant to a closed-loop control scheme, communication of the data in manners that compensate for, i.e., overcomes the effects of, fading exhibited on the communication channel.

The data communicated by the base transceiver station is provided thereto by way of the lines 32. The data is coded by channel encoders 34. Here, M channel encoders, corresponding in number to the number of transmit antennas, are used. Each of the channel encoders forms a fixed-rate coder of conventional implementation. The coder generates coded data, here on the lines 38, that is combined by multipliers 42 with values applied to individual ones of the multipliers by way of lines 44. In an implementation in which code-division multiplexing is utilized, the inputs on the lines 44 define spreading codes that provide channel differentiation by the values of the codes. And, in an implementation that utilizes frequency division techniques, the values provided on the lines 44 define mixing frequencies with which the coded data provided thereto is mixed.

Once operated upon by the multipliers 42, the data is selectably amplified by amplifiers 46. Amplification levels of the amplifiers 46 are selectable to cause the power levels of the data, once amplified, correspondingly to be of power levels dependent upon, and responsive to, the gain of the amplifiers to which the data is applied. And, the data, once amplified by the amplifiers 46, is applied to different ones of the transmit antennas.

The data, transduced into electromagnetic form and communicated upon the communication channel 20, is detected by the receive antennas 22. The receive antennas transduce the detected electromagnetic energy into electrical form and provide electrical representations of the detected data to a receive part 52 of the mobile station. The receive part 52 operates upon the indications of the data provided thereto and, here, is shown also to include a decoder 54 to decode the indications of the data. As the data detected by each of the receive antennas includes components communicated by way of different communication paths, such as the communication paths 24 and 26, from different ones of the transmit antennas, operations at the receive part separate into their component portions the contributions from each of the data sequences.

The mobile station further includes apparatus 58 of an embodiment of the present invention. The apparatus 58 is formed of functional entities, implementable in any desired manner, such as by algorithms executable by processing circuitry. The apparatus 58 is here shown to include a detector 62 that includes, or forms a channel estimator 64. The channel estimator is coupled to the receive part 52 to receive indications of the detections made by the antenna transducers 22. The channel estimator operates to estimate the sub-channels, i.e., the portions of the communication channel associated with the different ones of the communication paths, such as the communication paths 24 and 26 upon which data is communicated by the base transceiver station to the mobile station. In the exemplary implementation, linear space-time processing operations are performed. Channel estimations made by the channel estimator provide indications of the channel conditions on each of the sub-channels of the communication channel upon which the data is communicated to the mobile station by way of the different ones of the communication paths. Pursuant to the channel estimations, sequential decoding is performed in the exemplary implementation through the use of successive canceling. That is to say, decoding operations are performed upon data detected at a first of the receive antennas. And, the decoded information is used to facilitate decoding of data detected at a second of the receive antennas. And, the decoding operations are performed upon successive ones, as appropriate, of the data streams received at the receive antennas, each operation taking advantage of previous decoding operations.

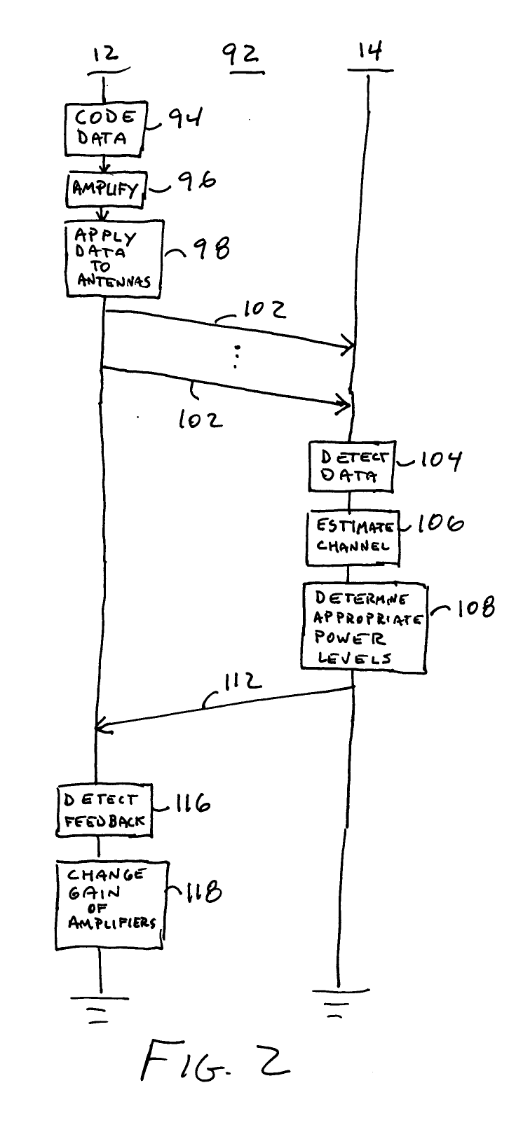

The apparatus also includes power controllers 66 coupled to receive indications of the estimations made by the channel estimator. As with other entities represented in FIG. 2, the power controllers are functionally represented. The power controllers 66 are of a number corresponding to the number of sub-channels on the communication channel. And, as the number of sub-channels corresponds to the number of transmit antennas 18, the power controllers 66 are of numbers corresponding to the number of transmit antennas 18.

The power controllers each operate to generate power change requests to request that the power levels at which data transmitted from different ones of the transmit antennas upon different ones of the sub-channels be changed. In the exemplary implementation, the requests are binary, indicating either a request to increase or a request to decrease the power levels. In other implementations, binary, or other, indications are generated that are to be interpreted in other manners. The requests generated by the power controllers 66 are provided to a transmit part 68 of the mobile station for return to the base transceiver station on a feedback channel. Thereby, the power change requests are provided, in closed-loop manner, to the base transceiver station.

The base transceiver station includes a receive part 72 that receives and operates upon the feedback returned to the base transceiver station. And, the base transceiver station further includes additional apparatus 58 of an embodiment of the present invention, coupled to the receive part to receive indications of the power control change requests returned by way of the feedback channel to the base transceiver station.

The apparatus embodied at the base transceiver station forming the communication station 12 includes a power control request receiver 74 coupled to the receive part 72 to receive indications of the power control change requests returned by way of the feedback channel. The receiver operates to detect the individual power change requests generated by the controller 66. And, the apparatus includes a power level changer 76 coupled to the power control change request receiver 74. The power level changer selectably generates signals on the lines 48 to cause change in the gain levels by which the amplifiers 46 amplify the data provided thereto. In the exemplary implementation in which the power change requests are incremental requests requesting incremental increase or decrease of the gain power levels of the data communicated upon the communication channel by way of different ones of the transmit antennas, the values generated by the power level changer 76 correspond to cause incremental increase or decrease in the gain of the respective amplifiers. Thereby, closed-loop power control is effectuated. Through appropriate selection of the power levels at which the data streams are communicated by individual ones of the transmit antennas, the power levels at which the data streams are communicated are great enough to compensate for the effects of fading of the data along the communication path that the data travels.

FIG. 2 illustrates a representation shown generally at 92, representative of operation of the communication system 10, shown in FIG. 1. Here, again, the communication station 12 forms a base transceiver station and the communication station 14 forms a mobile station. The representation 92 shown in the figure is, alternately, representative of operation of other sets of communication stations operable in an MIMO communication system.

First, and as indicated by the block 94, data that is to be communicated is coded at a fixed coding rate. The data, once coded, such as by space-time encoding techniques, is provided on separate lines to separate amplifiers to be amplified thereat, as indicated by the block 96. And, as indicated by the block 98, the data, formed into independent, or other, data streams, is applied to transmit antennas.

The data streams are communicated, indicated by way of the segments 102, upon separate communication paths upon a communication channel to the mobile station 14. Different ones of the communication paths exhibit different fading characteristics, and different levels of fading of the different ones of the data streams is evidenced pursuant to communication on the communication channel.

The receive antennas at the mobile station detect, as indicated by the block 104, the data streams communicated thereto by way of the different communication paths on the communication channel. Then, and as indicated by the block 106, estimation operations, such as linear space-time calculations, are performed to estimate the channel upon which the data is communicated. Estimations are performed for each of these sub-channels. Then, and as indicated by the block 108, determination of desired power levels, at least in terms of incremental increases and decreases, of the data communicated upon different sub-channels is made. Indications of the determinations are returned, indicated by the segment 112, by way of a feedback channel to the base transceiver station. And, the feedback information is detected, indicated by the block 116, and the gain of the amplifiers is selectably changed, as indicated by the block 118, responsive to the values of the feedback information. Thereby, closed-loop power control is effectuated to compensate for the effects of fading on the communication channel. Compensation is made on a communication path by communication path basis by altering power levels of the transmitted data. Changes in coding rates at which the data is encoded is not required, thereby permitting a fixed rate coder to be utilized.

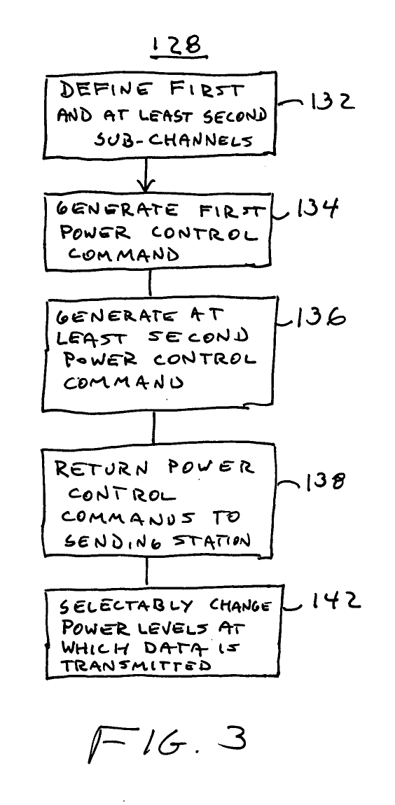

FIG. 3 illustrates a method flow diagram, shown generally at 128, of the method of operation of an embodiment of the present invention. The method facilitates effectuation of closed-loop power control in a radio communication system. The communication system has a sending station including a first selected number of transmit antennas from which selectably to send data upon a communication channel susceptible to distortion and a receiving station having a second selected number of receive antennas at which to detect the data communicated by the sending station upon the communication channel.

First, and as indicated by the block 132, first and at least second sub-channels are defined. Each of the first and at least second sub-channels are defined in parallel with one another, in which substantially independent data streams of the data are communicated upon individual ones of the first and at least second sub-channels.

Then, and as indicated by the blocks 134 and 136, first and at least second power control commands are generated for return to the sending station. The power control commands are to control power levels of the first and at least second data streams subsequently to be communicated upon the communication channel by the sending station.

Thereafter, and as indicated by the block 138, the power control commands are returned to the sending station. And, as indicated by the block 142, the power levels at which the data is transmitted by the sending station are selectably changed.

Thereby, compensation is made for the effects of fading, or other distortion, upon the communication channel through use of a closed loop power control scheme. Changes in the coding rate are not required to combat the effects of fading.

The previous descriptions are of preferred examples for implementing the invention, and the scope of the invention should not necessarily be limited by this description. The scope of the present invention is defined by the following claims.

1. In a radio communication system having a sending station having a first selected number of transmit antennas from which selectably to send data upon a communication channel susceptible to distortion and a receiving station having a second selected number of receive antennas at which to detect the data communicated by the sending station upon the communication channel, an improvement of apparatus for facilitating effectuation of closed-loop power control by which to control power levels at which the data is communicated by individual ones of the transmit antennas, said apparatus comprising:
a detector positioned at the receiving station and coupled to the second selected number of receive antennas to receive indications of the data detected at individual ones of the receive antennas, said detector for defining a first sub-channel and at least a second sub-channel, each of the first and at least second sub-channels defined in parallel with one another, substantially independent data streams of the data communicated upon individual ones of the first and at least second subchannels;
a first power controller adapted to receive indications of power levels of a first data stream communicated upon the first sub-channel defined by said detector, said first power controller for generating first power control commands for return to the sending station to control power levels of the first data stream subsequently communicated by the sending station;
at least a second power controller adapted to receive indications of power levels of at least a second data stream communicated upon the at least the second sub-channel defined by said detector, said at least second power controller for generating at least second power control commands for return to the sending station to control power levels of the at least the second data stream subsequently communicated by the sending station.

2. The apparatus of claim 1 wherein said detector comprises a channel estimator for estimating each of the first and at least second subchannels, the first and at least second subchannels formed by estimations made by said channel estimator.

3. The apparatus of claim 2 wherein said channel estimator further estimates values of the substantially independent data stream communicated upon the individual ones of the first and at least second subchannels.

4. The apparatus of claim 1 wherein the data communicated by the sending station upon the communication channel to the receiving station comprises space time encoded data and wherein said detector performs space time processing operations upon the indications of the space time encoded data.

5. The apparatus of claim 4 wherein the space time processing performed by said detector comprises decoding, in sequential and iterative manner, indications of the space time encoded data detected at each of the selected number of receive antennas.

6. The apparatus of claim 1 wherein the first and at least second sub-channels defined by said detector at least correspond in number with the transmit antennas from which the data is selectably sent.

7. The apparatus of claim 1 wherein the first and at least second sub-channels defined by said detector comprise a plurality of sub-channels, the plurality of sub-channels at least corresponding in number with the first selected number of transmit antennas from which the data is selectably sent.

8. The apparatus of claim 7 wherein said first and at least second power controllers, respectively, comprise a plurality of power controllers, each power controller of the plurality adapted to receive indications of power levels of individual ones of a corresponding plurality of data streams communicated upon a corresponding number of the plurality of sub-channels defined by said detector.

9. The apparatus of claim 1 wherein the first power control commands generated by said first power controller are generated to request power-level increase at which the data is communicated from a first transmit antenna of the selected number of transmit antennas.

10. The apparatus of claim 9 wherein the first power control commands generated by said first power controller are further generated to request power-level decreases at which the data is communicated from the first transmit antenna of the selected number of transmit antennas.

11. The apparatus of claim 1 wherein the second power control commands generated by said second power controller are generated selectably alternately to request increase and to request decrease of power levels at which the data is communicated from a second transmit antenna of the selected number of transmit antennas.

12. The apparatus of claim 1 wherein the data communicated by the sending station from the selected number of transmit antennas is encoded at a fixed coding rate and wherein said apparatus further comprises a fixed-rate decoder adapted to receive representations of the data detected at individual ones of the receive antennas, said fixed-rate decoder for decoding, at a fixed decoding rate, the representations of the data received thereat.

13. In the radio communication system of claim 1, a further improvement of apparatus embodied at the sending station, also for facilitating the effectuation of the closed-loop power control levels at which the data is communicated by the individual ones of the transmit antennas, said apparatus comprising a power control command receiver for receiving the first and at least second power control commands generated by said first and at least second power controllers, respectively.

14. The apparatus of claim 13 further comprising a power level changes coupled to said power control command receiver, said power level changer selectably operable, responsive to reception of the first and at least second power control commands at said power control command receiver, to change power levels at which the data is transmitted from selected ones of the transmit antennas.

15. A method for facilitating effectuation of closed loop power control in a radio communication system having a sending station including a first selected number of transmit antennas from which selectably to send data upon a communication channel susceptible to distortion and a receiving station having a second selected number of receive antennas at which to detect the data communicated by the sending station upon the communication channel, said method comprising the operations of:
defining, at the receiving station responsive to detections at individual ones of the receive antennas indications of the data transmitted to the receiving station, a first sub-channel and at least a second sub-channel, each of the first and at least second sub-channels defined in parallel with one another, substantially independent data streams of the data communicated upon individual ones of the first and at least second sub-channels;
generating first power control commands for return to the sending station to control power levels of the first data stream subsequently communicated by the sending station, the first power control commands for controlling power levels of the first data stream subsequently communicated by the sending station; and
generating at least second power control commands for return to the sending station to control power levels of the at least the second data stream subsequently communicated by the sending station, the at least the second power control commands for controlling power levels of the at least the second data stream subsequently communicated by the sending station.

16. The method of claim 15 further comprising the operation of returning the first and at least second power control commands, respectively, generated during said operations of generating to the sending station.

17. The method of claim 16 further comprising the operation of adjusting power levels at which the data is transmitted from first and second transmit antennas of the first selected number of transmit antennas responsive to return, during said operation of returning, of the first and at least second power control commands.

18. The method of claim 15 wherein said operation of defining comprises estimating the first and at least second sub-channels responsive to the detection of the indications of the data transmitted to the receiving station.

19. The method of claim 15 further comprising the preliminary operation of encoding the data transmitted by the sending station at a fixed encoding rate.

20. The method of claim 15 wherein the first and at least second power control commands generated during said operations of generating request incremental changes of power levels.
